(19) United States
(12) Patent Application Publication
(10) Pub. No.: US 2001/0032106 A1
(43) Pub. Date: Oct. 18, 2001

(54) Multi-environment scalable business system

(76) Inventors: Art Smith, Des Moines, IA (US); Dennis Johnston, Waukee, IA (US); Beth Rohwedder, Des Moines, IA (US); Kay Musal, Norwalk, IA (US); William Smith, Van Meter, IA (US); Gene Rawls, Johnston, IA (US); Eric C. Jones, West Des Moines, IA (US); Jan S. Corey, Des Moines, IA (US)

Correspondence Address: MERCHANT & GOULD PC, P.O. BOX 2903, MINNEAPOLIS, MN, 55402-0903, US

(21) Appl. No.: 09/751,837

(22) Filed: Dec. 29, 2000

Related U.S. Application Data
(60) Provisional application No. 60/174,127, filed on Dec. 31, 1999.

(51) Int. Cl. G06F 17/60; G06F 15/16

(52) U.S. Cl. 705/7; 705/35; 709/217

(57) ABSTRACT

Herein is disclosed a method and system for providing configurable on-line financial processing and data storage. Such a system is accessible to a client, and may include a storage facility storing a hierarchy of functions and financial data. The hierarchy of functions includes a plurality of task functions at a first level and a plurality of resource functions at a second level. Such a system also includes a processor in data communication with the storage facility. The processor is configured and arranged to receive an operation instruction and an argument from the client. Additionally, the processor is configured and arranged to invoke a task function in response to the operation instruction and to pass the argument to the task function. Further, the processor is configured and arranged to invoke at least one resource function in response to the invoked task function. Still further, the processor is configured and arranged to retrieve and process a set of financial data from the database. The set of financial data is processed by the at least one invoked resource function.

### REFERENCE TO CO-PENDING APPLICATIONS

This application claims priority based upon the filing date of U.S. Provisional Patent Application Ser. No. 60/174,127 filed Dec. 31, 1999 and entitled “MULTI-ENVIRONMENT SCALABLE BUSINESS SYSTEM.”

### TECHNICAL FIELD

This invention relates in general to a framework architecture, and more particularly to a dynamic integration of dissimilar applications in a distributed system by utilizing a common framework architecture.

### BACKGROUND

Consumer finance has changed dramatically over the last 20 years. In essence, it has generally moved from the small storefront office to modem office complexes fully equipped with modem office communication equipment and computers. The leaders in consumer finance have branched out into more traditional service areas such as banking and leasing. They have accomplished this broader scope of business while retaining their roots in loan processing. Consumer lending is a very competitive business. Many lenders look to the industry leaders to initiate effective lending practices and innovative approaches.

In this environment, aggressive tapping of nontraditional consumer lending sources is needed to meet profitability goals. More efficient ways of doing business are continuously being pursued, such as international markets, new products and new market channels. To manage the technology needed to move into this new era, the leaders tap their internal information services group to provide the leadership and strategic vision necessary to ensure continued success. In order to remain a leader in the industry, financial information services groups must recognize that the current technology used in supporting their subscriber base must be modified to support their new initiatives.

Part of the reason for changing the current technology base is that it has been recognized that current systems are unable to keep pace with the volume, rapidity and type of change requests coming from both internal and external users. Where change requests can be carried out, both the leaders and the subscriber base are expressing increasing concerns about the time to make system enhancements and the cost incurred not only in dollars expended, but also in lost opportunity costs. In addition, it is becoming much more difficult to attract new subscribers due to the lack of functionality and limitations in modification by the end user.

For these and other reasons, the leaders are looking to replace their legacy systems with new, state-of-the-art systems that will enhance data access rates, provide flexibility, reduce system maintenance, improve data integrity, conform to industry approved standards, ease systems integration and reduce operational costs.

Defining a new architecture requires immense resources. An appropriate system solution demands project management, enterprise architecture planning, prototyping and workflow analysis. The architectures for business and data applications are defined as a result of the intense analysis. The design, development and implementation of the replacement system are initiated after the architecture planning definition process has been completed. The architecture definition may define what is needed, and a plan supporting the architecture is needed to define how it will be implemented.

In the recent years, system engineering and data processing industries have been experiencing two major revolutions in computing, along with financial hurdles. The first is caused by the increasing complexity of software, which has resulted in the necessity of introducing new software engineering practices; object-oriented computing is the outcome. The second revolution is the rise of distributed computing. Although mainframe computing is still central in many corporations, some businesses have realized that these monolithic and expensive computers will not deliver the promises of tomorrow's information systems. Therefore, networks of computers are steadily replacing the mainframe.

Nevertheless, today's business systems lack an architectural framework built in the context of the business domain; components identified based on business usage. Typically, these frameworks need to be very technical in nature, designed to meet technical challenges and to solve technical problems such as dissimilar communication protocols utilized by application programs. Reusable, domain-specific processing is needed to provide a single, comprehensive system supporting a variety of business requirements in the financial services industry. Such a system would include an integration of all custom built components as well as third-party products. A sophisticated system that incorporates end-user interfaces behaves similarly, navigates easily, engenders configurability and reduces learning curves. Nevertheless, some key barriers must be overcome to achieve this goal.

For example, transaction response time on state-of-the-art systems is inadequate for providing efficient service to clients. Geographic diversity—the physical distance between locations and the time it takes to transfer messages between them—adds to the problem. Inadequate failure management and system maintenance may lead to excessive system downtime. Poor local infrastructure and system design result in continuous upgrades and retraining of personnel.

### SUMMARY

In general terms, the present invention is directed to an on-line financial processing and storage system. A processor receives an operation instruction and an argument and invokes a hierarchical set of functions in response to the operation instruction and passes the argument to at least one of the functions. The processor also retrieves a set of data from memory and one of the invoked functions processes data within the set of data.

One aspect of the invention relates to a component-based system for business domain-specific processing. The system includes a processor having a plurality of executable modules including a first, a second and a third module. The first executable module, having a plurality of process rules and conditional logic, is configured to receive a request and determines whether the request relates to a financial action or an operation action. The first executable module then invokes the action to initiate a sequence of business rules. The second and third executable modules are responsive to the first executable module, the financial action, and the operation action. The second executable module is configured to provide services. The third executable module is configured to retrieve and update stored financial and associated information in the storage medium, wherein additional information related to the specific information may be automatically retrieved.

Another aspect of the invention relates to a method of providing on-line financial services. The method involves executing a first executable module, having a plurality of process rules and conditional logic, which is configured to receive a request and determines whether the request relates to a financial action or an operation action. The method also involves invoking the action to initiate a sequence of business rules. Second and third modules are executed. The second and third modules are responsive to the first executable module, the financial action, and the operation action. The second module is executed to provide services. The third module is executed to retrieve and update stored financial and associated information in the storage medium, wherein additional information related to the specific information may be automatically retrieved.

Another aspect of the invention relates to a component-based system for business domain-specific processing. The component-based system may consist of a plurality of interfaces electrically interconnected to at least one framework processor. The framework processor consists of a plurality of executable modules including first, second and third module. The first executable module has a plurality of process rules and conditional logic, configured to receive a request, determine whether the request relates to a financial action and an operation action, and invoke the action to initiate a sequence of business rules and services. The second and third executable modules are responsive to the first executable module, the financial action, and the operation action. The second executable module is configured to provide services. The third executable module is configured to retrieve and update stored financial and associated information in a storage medium, wherein additional information related to the specific information may be automatically retrieved. The component-based system may also consist of a storage medium, connected to the processor, for collecting customer information and archiving data. Additionally, the component-based system may consist of a decision processor, interconnected to the framework processor, for reporting a plurality of activities relating to business transactions, wherein the decision processor performs data replication in plurality information repositories. Further, the component-based system may consist of a package solution process, interconnected to the framework processor, for providing a plurality of foreign knowledge bases.

Another aspect of the invention relates to a method of executing a financial processing rule. The method involves executing a rule-based function, and determining the state of a rule associated with the rule-based function. Next, when the state of the rule is false, execution of the rule-based function is completed without regard to the rule.

Another aspect of the invention relates to a rule-based system for processing financial information. The rule-based system may consist of a database of rules, each rule having a selectable state. Additionally, the system may consist of a processor loaded with executable code, including at least one rule based function. The executable code is programmed to access the database of rules, determine the state of one or more of the rules, and complete execution of the rule-based function.

Another aspect of the invention relates to an on-line financial processing and data storage system. Such a system is accessible to a client, and may include a storage facility storing a hierarchy of functions and financial data. The hierarchy of functions includes a plurality of task functions at a first level and a plurality of resource functions at a second level. Such a system also includes a processor in data communication with the storage facility. The processor is configured and arranged to receive an operation instruction and an argument from the client. Additionally, the processor is configured and arranged to invoke a task function in response to the operation instruction and to pass the argument to the task function. Further, the processor is configured and arranged to invoke at least one resource function in response to the invoked task function. Still further, the processor is configured and arranged to retrieve and process a set of financial data from the database. The set of financial data is processed by the at least one invoked resource function.

Another aspect of the invention relates to an on-line financial processing and data storage system. Such a system is accessible to a client, and may include a storage facility storing a hierarchy of functions and financial data. Such a system also includes a processor in data communication with the storage facility. The processor is configured and arranged to receive an operation instruction and an argument from the client. Additionally, the processor is configured and arranged to invoke a plurality of functions in response to the operation instruction and to pass the argument to at least one of the invoked functions. Furthermore, the processor is configured and arranged to retrieve and to process a set of financial data from the database. The set of financial data is processed by at least one of the invoked functions and forms an object descriptive of a business entity.

Another aspect of the invention relates to a method of providing on-line financial processing and data storage. Such a method is responsive to input from a client, and may include receiving an operation instruction and an argument from the client. Additionally, the method may include invoking a task function in response to the operation instruction and passing the argument to the task function. Further, the method may include invoking at least one resource function in response to the invoked task function. Still further, the method may include retrieving and processing a set of financial data from the database. The retrieved set of financial data is processed by the at least one invoked resource function.

Another aspect of the invention relates to an on-line financial processing and data storage system. Such a system may include a first on-line transaction processing system located in a first region and a first data storage facility storing financial data, also located in the first region. The first data storage facility is in data communication with the first on-line transaction processing system. Such a system may also include a second on-line transaction processing system located in a second region, wherein the second region is remote with respect to the first region. Further, such a system may include a second data storage facility in data communication with the second on-line transaction processing system and the first data storage facility. The first and second data storage facilities store at least some common financial data, and the first and second data storage facility synchronize at least some of the common financial data.

### BRIEF DESCRIPTION OF THE DRAWINGS

Referring now to the drawings in which like reference numbers represent corresponding parts throughout:

FIG. 1A depicts an exemplary client computing system interfacing with an on-line transaction processing system.

FIG. 1B depicts an exemplary subscriber networked to an on-line transaction processing system.

FIG. 2A depicts an account list Graphical User Interface (GUI).

FIG. 2B depicts an account detail GUI.

FIG. 3 is a depiction of one example of a multi-environment scalable business system.

FIG. 4 is another depiction of an example of a multi-environment scalable business system.

FIG. 5 depicts a client request propagating toward a machine within an on-line transaction processing system.

FIG. 6 depicts a task/search/query and its associated interfaces.

FIG. 7 is another depiction of an account detail GUI, in which a post payment selection is being selected from a drop-down menu.

FIG. 8 depicts a post payment GUI.

FIG. 9 is another depiction of a client request propagating toward a machine within an on-line transaction processing system.

FIG. 10 depicts one formation that the on-line transaction processor and remote database management system may take on.

### DETAILED DESCRIPTION

In the following description of various embodiments of the invention, reference is made to the accompanying drawings in which like reference numerals represent like parts throughout the several views. It is to be understood that embodiments other than those described herein may be utilized. Accordingly, structural and functional modifications may be made without departing from the scope and spirit of the present invention, which is defined and limited solely by the attached claims.

The disclosure herein relates to a multi-environment scalable business system, which was disclosed in a provisional application, entitled “MULTI-ENVIRONMENT SCALABLE BUSINESS SYSTEM,” filed on Dec. 31, 1999, Application No. 60/174,127, the disclosure of which is hereby incorporated by reference.

In general terms, the present invention is directed to an on-line financial processing and storage system. A processor receives an operation instruction and an argument and invokes a hierarchical set of functions in response to the operation instruction and passes the argument to at least one of the functions. The processor also retrieves a set of data from memory and one of the invoked functions processes data within the set of data. In one embodiment, the hierarchical set of functions may be categorized as consisting of task functions and resource functions (which are called by task functions). In another embodiment, the processor executes a persistence service, which retrieves financial data from a database and creates therefrom a set of financial-related data, which is an object descriptive of a business entity. In another possible embodiment, the persistence service also retrieves personal or other business data, which may be related to the financial data or may be independent from any particular financial data.

Additionally, the invention described herein can take on many different forms and embodiments. Examples include apparatuses, methods, and propagated signals that are formed or created according to certain methods.

As used herein, the term “business entity” refers to a party (such as an individual applying for a loan) or an individual asset or liability (such as a loan account or an account receivable) pertaining to a business setting. The term “business object” is used to refer to a set of data/attributes, which are descriptive of a business entity (for example, a business object describing an individual may consist of a set of data including a name, social security number, annual income, list of assets, list of liabilities, etc.). The term “service” is used to refer to a set of functionality made available to other software, whether it be made available: (1) by virtue of its being run-time linked, as a dynamic link library (DLL); (2) via an application interface (API); (3) by virtue of its being a separate executable, to which a foreign executable messages its interaction; (4) by virtue of its being compile-time linked with its calling software; or (5) by virtue of any other means generally making the functionality of the service available to foreign software.

This disclosure presents various portions of the aforedisclosed multi-environment scalable business system by describing an exemplary commercial application of the system. The disclosed system herein has many commercial applications and the commercial application discussed herein is used merely as a vehicle to introduce and describe various portions and features of the system. Herein, reference is made to functions or services, which are executed by a processor. Such functions or services, when executed by a processor, define a new and particularized structure for the processor.

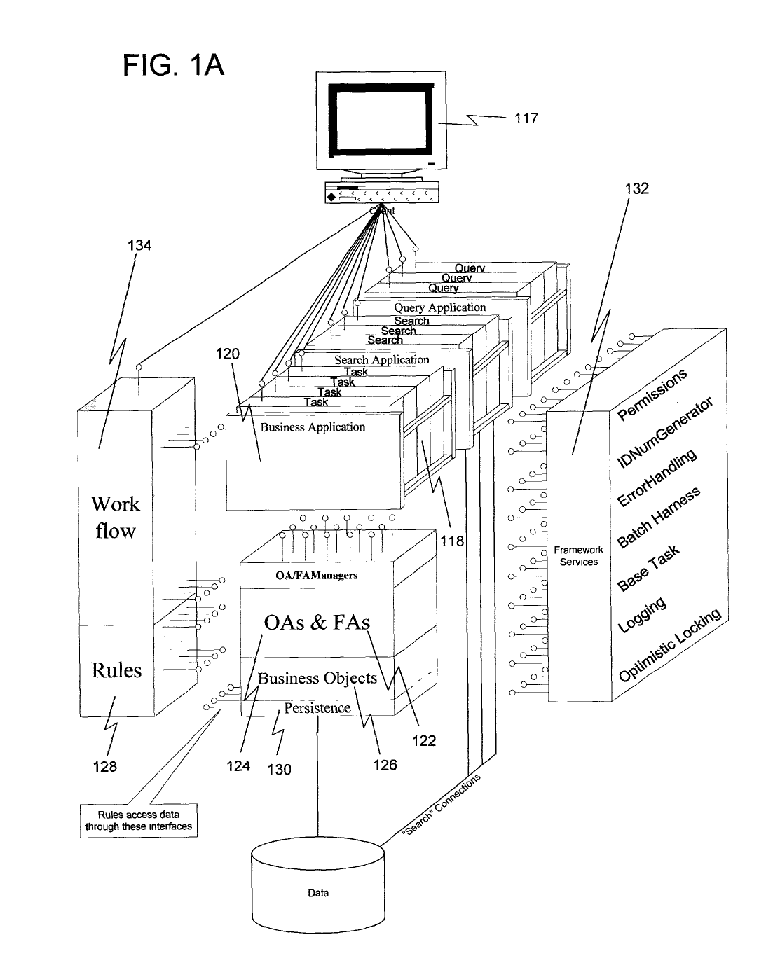

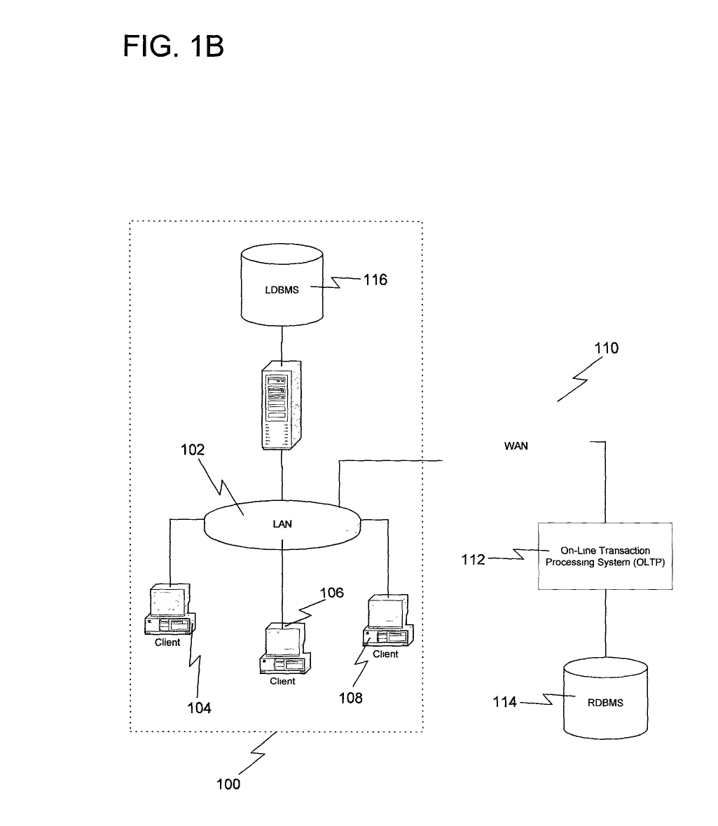

The multi-environment scalable business system disclosed herein is a distributed computing system that permits subscribing members to handle all manners of financial bookkeeping. As is depicted by FIG. 1A, the multi-environment scalable business system permits a client computing system 117 of a subscribing member—a business that makes use of the system described herein—to perform operations related to finance by accessing functionality provided by “tasks/search/query” functions 118, which may be aggregated into various sets, each of which are referred to as a “server” 120. These task/search/query functions 118 may be distributed across many computing nodes (a computing node is a general term referring to a computing/processing device connected to a network). Each task/search/query function 118 may correspond to a particular operation needing to be performed by the client computing system 117. Thus, a client computing system 116 may access one task/search/query function 118 to perform one operation, such as opening an account, and would access a different task/search/query function 118 to perform a different operation, such as posting a payment to that account. Each computing node on which the task/search/query functions 118 reside may provide a set of resources to assist the task/search/query functions 118 in performing their assigned operations. These resources may be embodied as functions that are linkable—either at run time or compile time—with the task/search/query functions 118. Alternately, these resources may be embodied as services interacted with via an application interface (API). These resources will be discussed in greater depth in the disclosure to follow (as will other aspects of the multi-environment scalable business system). Examples of resources may include: (1) a set of financial actions 122 (which are functions that deal with the pecuniary aspects of financial data); (2) operation actions 124 (which are functions that deal with the non-pecuniary aspects of financial data); (3) business objects 126 (which are objects having attributes descriptive of a business entity); (4) rules 128 (which are functions—also referred to as “rule functions”—that interact with business objects to determine particular qualities about the entities described by the business object); (5) a persistence service 130 (which is a service that interacts with a datastore, such as a database, to create business objects from the individual data items stored therein); (6) framework service 132 (which are functions that provide functionality related to use of the multi-environment scalable business system, itself—such as printing, batch processing, and checking security permissions); and (7) a workflow service 134 (which queues and organizes work to be performed by employees of the subscribing members).

Depicted in FIG. 1B is consumer finance company 100, which is one example of a subscriber. Many other examples of subscribers exist. Consumer finance company 100 generally provides financing for consumer purchases. For example, consumer finance company 100 may provide financing for a customer who purchases furniture from a furniture retailer under a payment plan. Thus, at the time of purchase, the consumer finance company 100 extends a loan to the customer for the price of the furniture. A record of the loan, including its various terms will be kept by the consumer finance company 100.

This framework is advantageous for such lending systems, because it provides a fully integrated system. Rather than having multiple systems upload and download information to perform various tasks in the lending cycle, the framework described herein allows a user or an institution to seamlessly use a single system to accomplish loan origination, loan servicing, loan marketing, and processing a loan after maturity.

Although the following example is directed to a consumer finance company posting a payment, it may be used for many other functions and application. For example, the framework described herein may support sales plan or direct marketing capabilities in which financial plans or other packages are dynamically created on-line in a what-if environment and then locked in and automatically utilized in e-mails, letters, or even electronic images for presentations. Another application for the framework bay be query and direct marketing function in which users are able to query a database within the system and send on-line direct marketing mailings to a customer list.

Yet another application for the framework may provide a networked kiosk similar to an automatic teller machine, or may provide an automatic teller machine, that provides an application for credit. A customer can complete the application at the kiosk without the aid of another person such as a sales person or other banker. Additionally, this automated and networked credit application may be transmitted to a wireless terminal that functions as the networked kiosk. Examples of such networked terminals may include Internet accessible cellular phones and palm-held devices. The kiosks and wireless terminals may be networked to the framework using any appropriate network such as the Internet, Intranet, a local-area network, a wide-area network, or a dedicated network link.

The consumer finance company 100 possesses a local area network 102 to which various clients or computing systems 104, 106, 108 are attached. The computing systems 104, 106, 108 are used by operators employed by the consumer finance company 100 to process transactions relating to various accounts handled by the consumer finance company 100. For example, the operators may use the computing systems 104, 106, 108 (which may possess a terminal for the operator to interact with) to post a payment to a particular account, to change the billing address of a particular account, to record a repossession with respect to a particular account, or to perform any other function upon an account. The client computing systems 104, 106, and 108 are computers that execute a client computer program, which is a program that requests data from an OLTP as described herein.

In order to obtain the account keeping capabilities needed for its business, consumer finance company 100 could design or purchase software for this purpose. This avenue of proceeding presents many challenges, however. For example, consumer finance company 100 may have facilities dispersed across the world, meaning that any software package it used would have to possess the capacity to communicate account information to each of its facilities and to easily expand as new facilities are opened. Additionally, because consumer finance company 100 is likely to evolve its business to provide related services in other fields, the capabilities of the software will have to be easily expanded and customized for its various facilities, which are involved in different finance-related fields. Another challenge results because consumer finance company 100 is likely to periodically upgrade its computing facilities and its software will have to port easily from platform to platform. In short, consumer finance company 100 will want its business system to be scalable, configurable, customizable and platform-independent.

By becoming a subscriber to the multi-environment scalable business system, the consumer finance company 100 can integrate its local computing facility with the multi-environment scalable business system, and in so doing, will be provided with the functionality it needs, while also achieving the goals of scalability, configurability, customizability, and platform-independence. As stated earlier, consumer finance company 100 is an example of a subscriber. As a subscriber, consumer finance company 100 must establish a network connection 110 between its local area network (LAN) 102 and an on-line transaction processing system (OLTP) 112, which is described in greater detail herein. The form of network connection providing connectivity between LAN 102 and OLTP 112 is a matter of design choice and may include any form of wide area network (such as a public frame relay network). OLTP 112 has access to a remote database management system (RDBMS) 114, also called a “remote memory facility,” which is a data storage facility that contains, amongst other data, data necessary for the record keeping of its subscribers. For example, RDBMS 114 contains a record of the loans issued by consumer fiance company 100. Finally, a local database management system (LDBMS) 116, also referred to as a “subscriber memory facility,” is maintained at the subscriber site 100. LDBMS 116 contains a subset of the data stored in RDBMS 114 and will be discussed in greater detail below.

Additionally, there are many possible embodiments of the OLTP 112 and the RDBMS 114. In one possible embodiment for example, the RDBMS 114 is formed with a single memory unit within a storage facility. Alternatively, the RDBMS 114 is formed with multiple memory units within a storage facility. Furthermore, the RDBMS 114 can be distributed among a plurality of storage units. In yet another possible embodiment, the OLTP 112 can include and execute a client computer program and thus serve as a client itself.

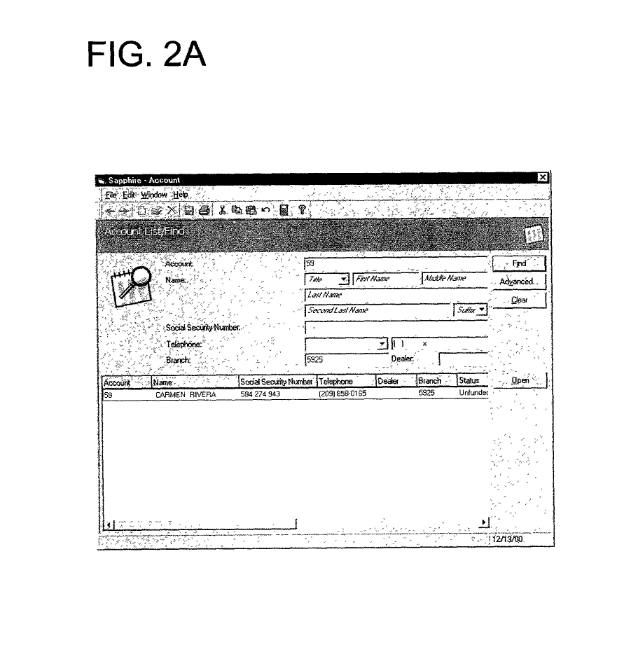

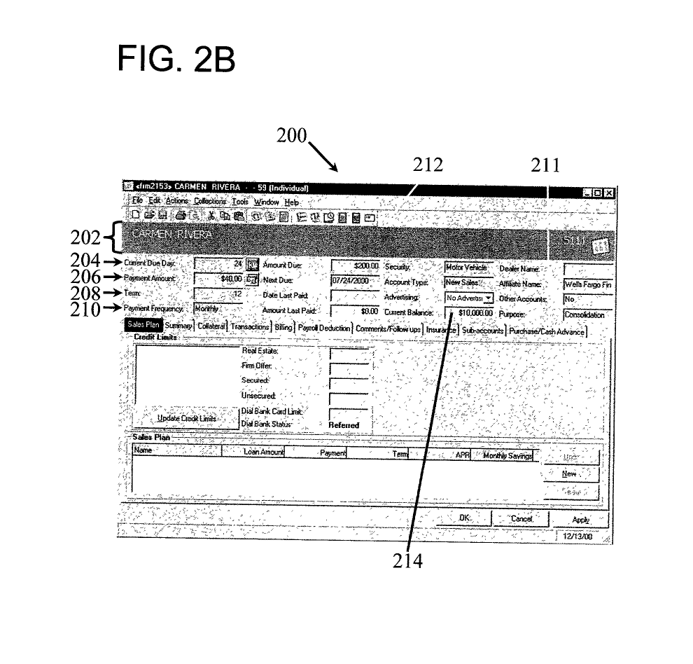

For the sake of illustrating the design and functional relationship of client computing systems 104, 106, 108, LDBMS 116, OLTP 112, RDBMS 114, and other components, the exemplary subscriber (consumer finance company 100) will be assumed to be presented with the following situation. A consumer who has purchased a couch from a furniture retailer under a payment plan financed by consumer finance company 100 has driven to the consumer finance company site 100 and has presented a check to an operator for the purpose of making a payment on his loan. In response, the operator begins a process, utilizing a client computing system 104, 106, or 108, of recording the consumer's payment (a process referred to as “posting a payment”). The operator begins the process of posting the payment by searching the RDBMS 114 (a search is another example of an operation performed by the multi-environment scalable business system disclosed herein, but its details are not discussed for the purpose of this example) to locate the account of interest, and selecting the account on which payment is to be posted, as depicted by FIG. 2A. The operator's computing system 104, 106, or 108 should respond to the operator's selection by presenting the operator with a graphical user interface revealing the details of the user's account. An example of such a graphical user interface (GUI) is depicted in FIG. 2B.

As can be seen from FIG. 2B, an account detail GUI 200 should present a set of information describing the consumer's loan. For example, the consumer's name, “Carmen Rivera,” is presented on a banner 202 running across the top portion of the GUI 200. Other information may be presented, such as the current due day 204, payment amount 206, term of the loan 208, frequency of payment 210, amount due 212, and current balance 214. The multi-environment scalable business system presented herein coordinates the functions of its various components to make the presentation of such a GUI 200 possible.

Additionally, the body of GUI's within the system utilizes a tree navigation structure and multiple layers of tabs that permit one-click navigation to many functional areas of the framework system. For example, GUI 200 has a plurality of tabs 211 that provide one-click navigation to a summary as well as information about collateral, transactions, billing, payroll deduction, general comments entered by a user, insurance, sub-accounts, and purchase/cash advances. An advantage of this navigation tree is that it provides improved customer service because a user can more quickly access information, perform analysis, and identify problems.

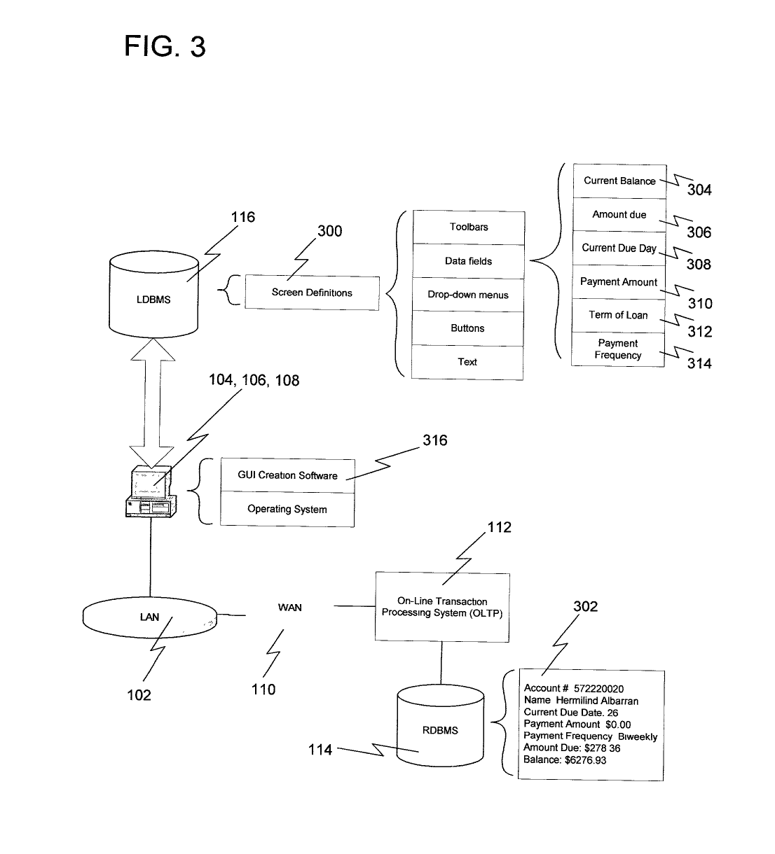

FIG. 3 illustrates one possible division of labor amongst the computing system 104, 106, or 108, OLTP 112, LDBMS 116, and RDBMS 114 with respect to creating and populating the account detail GUI 200 of FIG. 2. The nature of the division of labor depicted in FIG. 3 exists for the creation of all GUIs within the multi-environment scalable business system. As can be seen from FIG. 3, the LDBMS 116 stores a set of screen definitions 300 (referred to as “GUI data”). The screen definitions 300 stored in LDBMS 116 are retrieved as needed by the client computing systems 104, 106, or 108, which execute GUI creation software 316 designed to turn a screen definition into a functioning GUI. The data that populates the account detail GUI 200, or any other GUI, resides in RDBMS 114. Thus, the GUI creation software 316 resident on each computing system 104, 106, 108 uses the screen definitions 300 from the LDBMS 116 and account data 302 from the RDBMS 114 to create any given GUI, including the account detail GUI 200.

The screen definitions 300 stored in LDBMS 116 include definitions of each element within each GUI. For example, each item of text, button, drop-down menu, data field, and toolbar—including placement of the element, graying of the element, size of the element, etc.—is defined by the screen definition 300 pertaining to a given GUI. Accordingly, the presence of data fields on the account detail GUI 200 to present the current due day 204, payment amount 206, term of the loan 208, frequency of payment 210, amount due 212, and current balance 214 are indicated by corresponding data field definitions 304-314. Thus, that the current due day should be presented on the account detail GUI 200 is indicated by the current due day data field definition 308; the actual due day, itself (the 26th), is found in account data stored in the RDBMS 114.

Each screen definition 300 is stored centrally in the RDBMS 114, as well as being stored at the client site in LDBMS 116. Periodically, these screen definitions are transmitted to the various subscriber LDBMSs. Thus, screen definitions can be rapidly changed for an entire organization, subset of an organization, or users within an organization, by changing the screen definitions centrally and permitting those changes to be replicated to subscriber LDBMSs.

Also illustrated by FIG. 3, is that the definition of each GUI is maintained at the LDBMS 116 located at the subscriber's facility, but that the data required to populate each GUI is stored centrally at the RDBMS 114. Therefore, the definition of a particular GUI need not traverse the WAN 110 each time that GUI is to be opened. Only the data needed to populate the GUI must traverse the WAN. This arrangement permits each window to be opened and populated quickly, while minimizing the duplication of data throughout the system (i.e., if the data used to populate the window were stored at the LDBMS 116 at each subscriber facility, the consequence of each transaction would have to be replicated for each LDBMS accessed by the particular subscriber).

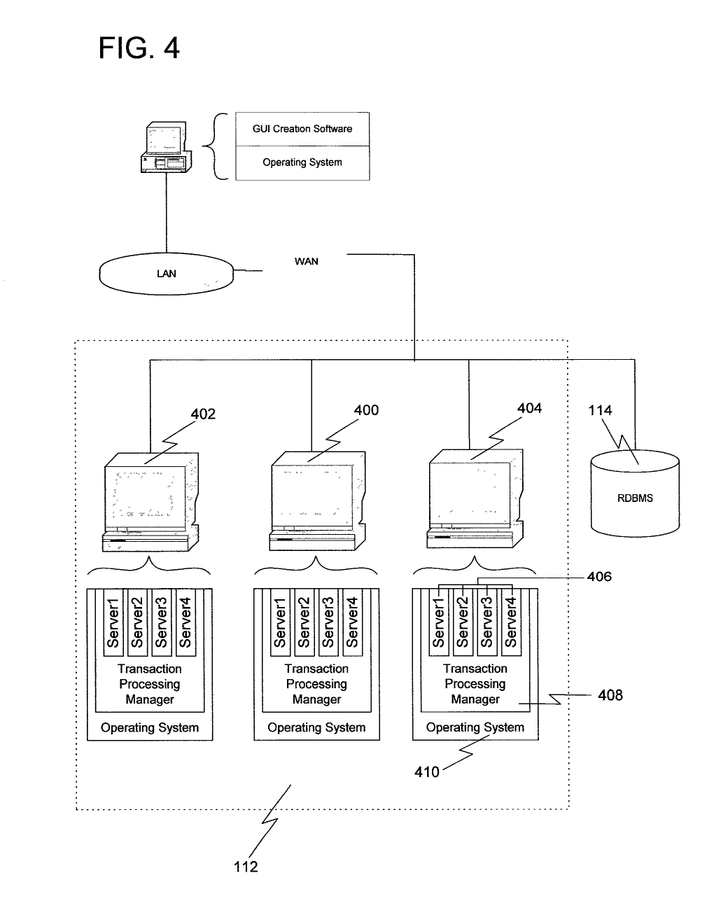

Turning to FIG. 4, the client computing system 104, 106, or 108 and OLTP are depicted in greater detail. The discussion relating to FIGS. 4, 5, and 6 (below) describes in greater detail the process of populating the account detail GUI 200, and thereby reveals the functional relationship and structure of the multi-environment scalable business system.

The client computing system 104, 106, or 108 requests data from the OLTP 112 to populate the account detail GUI in the same manner that it requests the OLTP 112 to do any other operation—it transmits a client request to the OLTP 112. As depicted in FIG. 4, the OLTP 112 is a collection of networked processing nodes 400, 402, 404, each of which has access to RDBMS 114. Although OLTP 112 is depicted as consisting of three networked processing nodes 400, 402, 404, in other embodiments, the OLTP 112 may consist of any number of networked processing nodes. Each processing node executes (using at least one processor) an operating system 410, a transaction process manager 408, and a set of servers 406, each of which may be stored on a local memory facility. A “server” is a unit of software that receives a client request, processes that request, and responds to it (in this context, the term “server” should not be confused with its more widely-used meaning to describe a piece of hardware that disseminates files to clients). A transaction process manager 408 is a unit of software that, amongst other things, directs a particular client request toward a particular server interface. Another function of the transaction process manager 408 is that of tracking the processing load of each task, and balancing that load for the sake of efficiency.

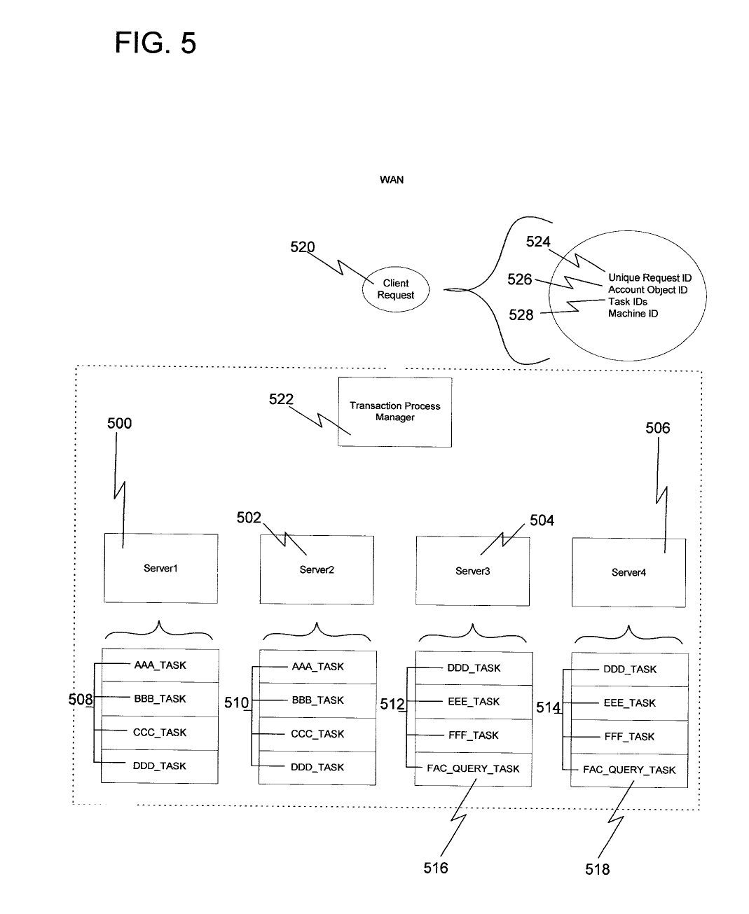

FIG. 5 depicts one possible division of labor amongst servers. Not all servers can respond to every form of client request. Accordingly, the transaction process manager 408 may serve a function of directing a particular client request to a server that is capable of handling it. The division of labor amongst servers 500, 502, 504, 506 is depicted by each server having access to a particular set of tasks 508, 510, 512, 514. A task is a function corresponding to a particular operation that may be requested by client computing systems 104, 106, 108. In our example in which an account detail GUI 200 is to be populated with data concerning a particular consumer's account, the client computing system emits an account-detail request 520, which is an operation requested by the client computing system, which is, in turn, handled by a particular task, the FAC_QUERY_TASK. Thus, because only server3 504 and server4 506 have access to FAC_QUERY_TASK, the transaction process manager 522 would have to direct the account-detail request 520 toward either server3 504 or server4 506.

As shown in FIG. 5, a client request may be a set of information transmitted to the OLTP 112 for the purpose of requesting that an operation be performed. FIG. 5 depicts the particular client request relevant to our example, an account-detail request 520. The structure of an account-detail request 520 is similar to that of all other client requests. It contains a unique request identifier 524, also referred to as an “operation instruction,” which corresponds to the task being requested (in this case, the unique request identifier corresponds to the FAC_QUERY_TASK 516 or 518). Additionally, a set of appropriate arguments is also contained in a client request. In this case, the set of arguments includes an account object identifier 526 (to identify the particular account which is to be queried) and a set of subordinate task identifiers 528 (which identify a set of tasks to be called by FAC_QUERY_TASK—each of the subordinate tasks correspond to functionality required to retrieve a particular set of data to be presented upon the account detail GUI 200). An account object identifier may herein be referred to as an “account OID.” Also included in a client request is a machine identifier, identifies which particular processing node within the OLTP 112 the client request is to be sent to.

Returning briefly to FIG. 3, client computing system 104, 106, or 108, may possess a service that permits the GUI creation software 316 to regard each server as an object, and each task within a server as a method of its respective object. This service may take the form of a library of functions that are linked with the GUI creation software 316 at compile time or run time. For example, such a library may provide a function that receives a server identifier and a task identifier, and returns a pointer to an object, which the GUI creation software 316 will regard as a means of interfacing with a given server. Such a service may also be embodied as a separate executable unit of software. Accordingly, the process of generating a client request may not be reflected by the structure of the GUI creation software 316, itself.

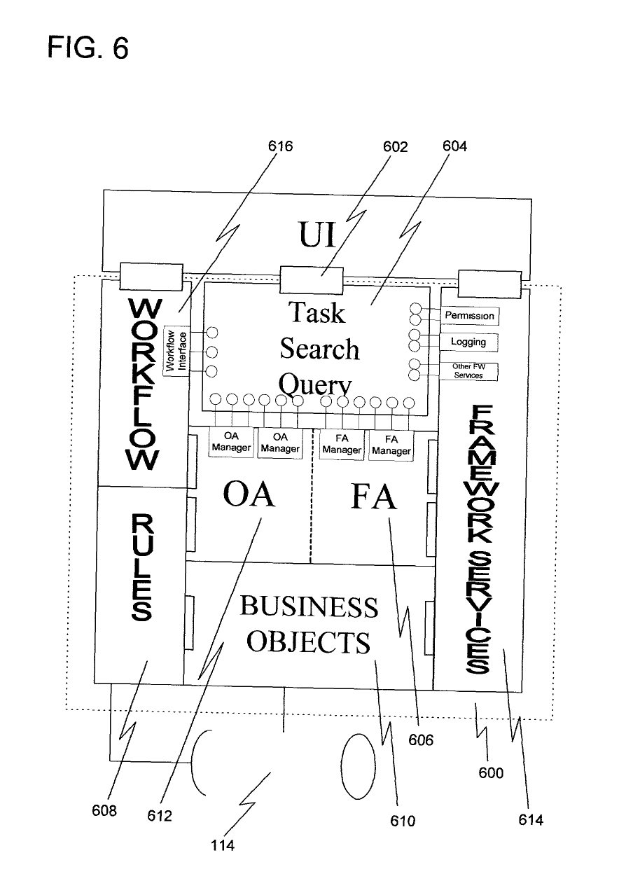

FIG. 6 depicts a task/search/query and its associated interfaces 600. The server uses the transaction process manager 602 as an interface. The transaction process manager 602 receives a client request (in this case, an account-detail request) and may perform two functions: (1) identifies the proper task to invoke; and (2) passes the arguments from the client request to the appropriate task. A task is a set of executable code invokable by the transaction process manager 602, and is designed to direct the performance of a particular operation by making use of reusable portions of software, referred to as “operation actions,” “financial actions,” or “framework services.” In the case of our example, the FAC_QUERY_TASK is invoked by the transaction process manager 602 with the following arguments: (1) an account object identifier; and (2) a set of subordinate task identifiers. Tasks are represented by the Task/Search/Query functional block 604.

The FAC_QUERY_TASK proceeds by invoking its first subordinate task, PAID_TO_DATE_TASK. The purpose of the PAID_TO_DATE_TASK is to arrive at the figure to be presented in the amount due data field 212 on the account detail GUI 200, and to return that value to the FAC_QUERY_TASK. In accomplishing that job, the PAID_TO_DATE_TASK calls a function referred to as the paid to date function. The paid_to_date function is categorized as a “financial action.” Financial actions are a set of functions made available to tasks to assist in performance of their jobs, and may be linked with tasks either at run time or compile time. Financial actions are intended to be reusable, in that they provide the sort of functionality that is potentially useful to more than one task. Financial actions are functions that deal with the pecuniary aspects of financial data. Financial actions are represented by the Financial Actions functional block 606. Additionally, these individual financial actions may be aggregated as a set of methods relating to an object residing within the Financial Actions functional block 606.

The paid_to_date financial action makes use of several rules to perform its job of determining the figure to be presented in the amount due data field 212 on the account detail GUI 200. Rules are functions that are made available to financial actions, operation actions (not yet discussed), and framework services (not yet discussed) to assist those functions in performing their tasks. These functions may be linked with their calling functions (financial actions, operation actions, and framework services) either at compile time or run time. Additionally, these rules may be aggregated as a set of methods relating to an object residing within the Rules functional block 608. Rules interact with a set of data describing a business entity (referred to as a “business object”) to determine a quality about that entity. For example, the paid_to_date financial action calls several rules to determine qualities about the consumer's account. The rules called by the paid_to_date financial action may include a get_installments_due rule, a calculate_interest_due rule, a calculate_charges rule, and a calculate_fees rule. These rules will interact with the RDBMS 114 via a persistence service designed to combine individual entries pertaining to a business unit within a database (RDBMS 114) into a business object (a process referred to as “instantiating” a business object). For example, the calculate_interest_due rule may interact with a business object representative of the consumer's account to determine a particular quality about the account—the amount of interest currently due. The calculate_interest_due rule will draw upon attributes of a business object representing the consumer's account (such as the balance of the account, interest rate of the account, state laws governing the account, etc.) to perform the calculations necessary to arrive at the amount of interest currently due. Similarly, the other rules mentioned as being called by the paid_to_date financial action will interact with the business object representing the consumer's account to determine other qualities about that account (number of installments due, charges to the account, fees to the account). Once determined by their respective rule, those qualities will be returned to the paid_to_date financial action, so that the financial action can use those qualities to calculate the figure to be presented in the amount due data field 212 on the account detail GUI 200. Finally, this figure is returned to the PAID_TO_DATE_TASK, which, in turn, returns the figure to the FAC_QUERY_TASK.

Upon completion of the PAID_TO_DATE_TASK, the FAC_QUERY_TASK will invoke, in sequence, its remaining subordinate tasks. As was illustrated in FIG. 5, a set of subordinate task IDs 528 may be transmitted as part of the client request 520. These subordinate task IDs identify tasks that are to be invoked by the FAC_QUERY_TASK. In this case, the subordinate tasks-GET_DELINQUENCY_STATUS_TASK, GET_BALANCE_TASK, and GET_NEXT_PAYMENT_INFO_TASK—are used to provide data that populates other data fields on the account detail GUI 200. For example, the GET_BALANCE_TASK may be used to supply the data that populates the current balance data field 214. Similarly, the GET_NEXT_PAYMENT_INFO_TASK may be used to obtain the data used to populate the remaining data fields on the account detail GUI 200. Like the PAID_TO_DATE_TASK, each of the other subordinate tasks may make use of financial actions and rules to obtain their respective figures, and each returns their respective figures to the FAC_QUERY_TASK. The set of figures used to populate the account detail GUI 200 are then returned to the client computing system 104, 106, or 108, and the GUI creation software 316 residing thereon populates the account detail GUI 200. The GUI creation software 316 having populated the account detail GUI 200, the window appears, populated with account data, as shown in FIG. 2.

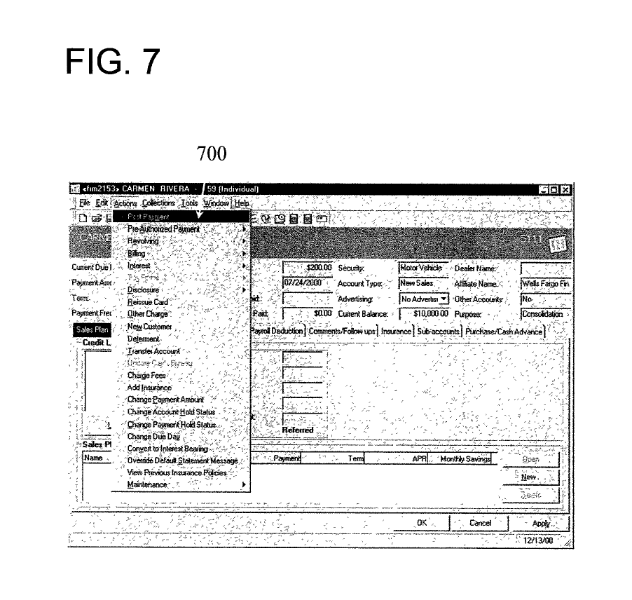

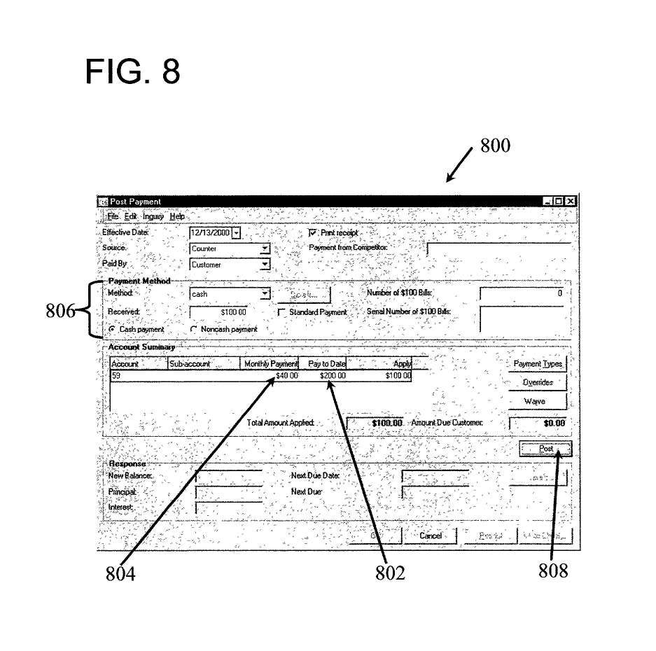

Continuing with our example, the operator is presented with an account detail GUI 200 populated with the particular consumer's account information, as a result of the aforedescribed actions of the OLTP 112. As a next step in posting the consumer's payment, the operator may select the “post payment” option 700 from the “actions” drop down menu, as shown in FIG. 7. In response, the client computing system 104, 106, or 108 is to provide the operator with a post payment GUI 800, shown in FIG. 8. The post payment GUI 800 presents the operator with a subset of the information that was presented to the operator on the account detail GUI 200, but permits the operator to enter information regarding the payment to be posted. In this case, the information provided to the operator is the pay to date FIG. 802 and the monthly payment FIG. 804.

The pay to date data 802 and monthly payment data 804 are obtained for the post payment GUI 800 in the same way that they were obtained for the account detail GUI 200—the PAID_TO_DATE_TASK is called (once again, using the consumer's account OID as an argument) via a client request to a particular machine comprising the OLTP 112. The ensuing sequence of events performed by the particular machine handling this client request is congruous in form to the sequence of events that precipitated from the account-detail request 520 used to populate the account detail GUI 200. More specifically, the transaction process manager 522 on the particular machine receiving the client request directs the request toward a server having access to the PAID_TO_DATE_TASK. In turn, the PAID_TO_DATE_TASK is invoked with the account OID corresponding to the particular consumer's account, and it begins the process of arriving at the pay to date data 802 and monthly payment data 804 by calling the paid_to_date function (a financial action, represented by logical block 606). The paid_to_date function responds by invoking various rules, which interact with an object representing the consumer's account (this object is represented by logical block 610) to determine various qualities about the particular consumer's account. The paid_to_date function uses those qualities to determine the pay to date data 802 and monthly payment data 804 used to populate the post payment GUI 800. Finally, the two units of data are returned to the PAID_TO_DATE_TASK, which returns those units of data to the client computing system 104, 106, or 108, whereupon the GUI creation software 316 residing thereupon populates the post payment GUI 800.

Once the post payment GUI 800 is populated with the appropriate data, the operator is able to perform the final steps of recording a payment—entering the consumer's payment information and initiating a post payment operation. The operator enters the payment information, such as the payment amount and the payment method in the payment-method box 806. Next, when the operator is ready to initiate the posting of the payment, the operator selects the post payment button 808.

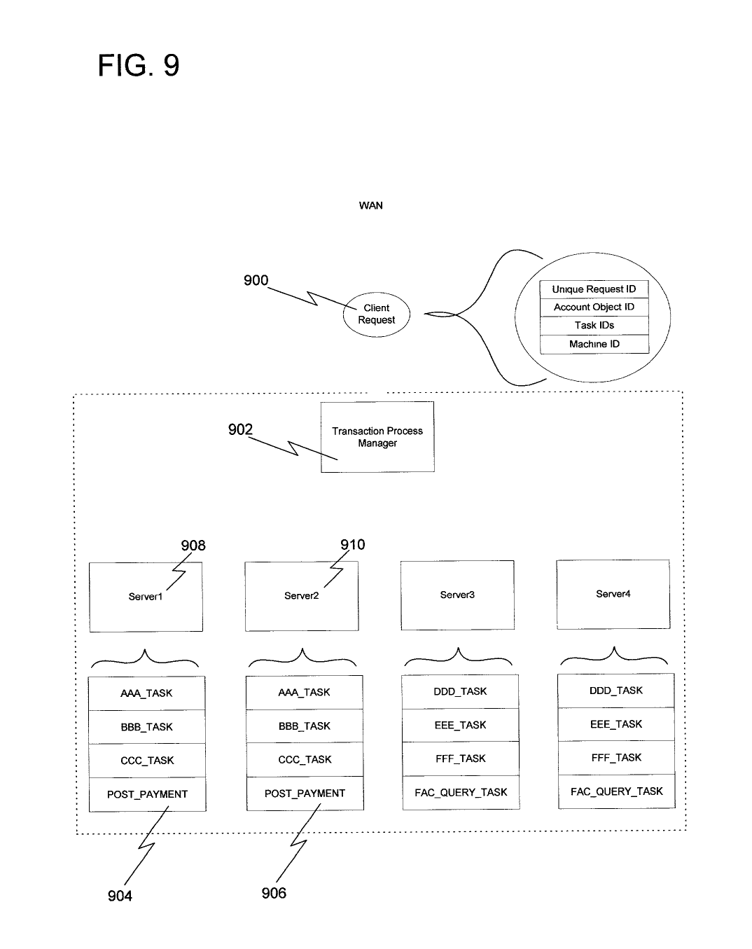

The selection of the post payment button 808 initiates the transmission of a client request 900 (this particular client request is known as a “post-payment-task request”), as shown in FIG. 9. The post-payment-task request 900 may contain: (1) a unique request identifier that corresponds to the POST_PAYMENT TASK, and (2) a set of arguments, such as the account OID identifying the consumer's account, the payment amount, and the payment method. As described previously, the client request is received by the transaction process manager 902, which may perform two functions: (1) identifies the proper task to invoke; and (2) passes the arguments from the client request to the appropriate task. In this case, the transaction process manager 902 invokes the POST_PAYMENT_TASK 904 or 906 residing within server1 908 or server2 910.

The POST_PAYMENT_TASK utilizes a financial action, an operation action and a framework service in carrying out the operation of posting a payment (in contrast, the previously discussed tasks utilized only financial actions in carrying out their operations). With reference to FIG. 6, a financial action is represented by logical block 606, an operation action by logical block 612, and a framework service by logical block 614. As stated earlier, financial actions 606, operation actions 612, and framework services 614 are collections of functions made available to tasks, for the purpose of assisting tasks in the performance of their assigned operation. These collections of functions are linkable (either at run time or compile time) with the functions comprising the task/search/query 604 logical block. Further, as also stated above, the functions comprising financial actions 606, operation actions 612, or framework services 614 may be aggregated as a set of methods relating to an object residing within their respective logical block. Financial actions 606, operation actions 612, and framework services 614 from each other mainly (although not exclusively) in terms of the sort of services they provide to the tasks that call them. As stated previously, financial actions 606 deal with the pecuniary aspects of financial data. Conversely, operation actions 612 deal with the non-pecuniary aspects of financial data (an example of an operation action will be provided below). Finally, framework services 614 provide functionality related to use of the multi-environment scalable business system, itself (such as printing and checking security permissions).

Returning to the specific operations involved in posting a payment, the POST_PAYMENT_TASK responds to its having been invoked by calling a PostCEPmt financial action. The PostCEPmt financial action is another example of a function that manipulates pecuniary aspects of a business object and is made available to a task function. Thus, PostCEPmt function is classified as a financial action. The PostCEPmt function proceeds to apply the appropriate rules 608 to a business object 610 representing the consumer's account, so as to properly reflect the consequence of applying the payment sum to the consumer's account. For example, the PostCEPmt financial action will call the appropriate rules needed to determine how much of the payment should be applied to interest on the account, insurance for default, fees (such as late charges), and to principal. When the appropriate rules have interacted with the business object representing the client's account, so as to calculate the consequences of the consumer's payment, the business object data is presented to the RDBMS 114 for storage by the persistence service (the same service that created the business object by interaction with the RDBMS 114). Thus, RDBMS 114 is updated to reflect the payment.

The POST_PAYMENT_TASK next calls a particular framework service 614 that performs a certain type of permission check. The framework service 614 called by the POST_PAYMENT_TASK first checks to see if the consumer's account—the financial figures of which have just been updated—has a negative balance (meaning that the consumer finance company 100 would be indebted to the consumer), as a result of the payment. Functions that are framework services 614 may interact with a business object representing the consumer's account, and thus may check for a negative balance. As recounted earlier, a persistence service combines various data elements stored in the database comprising RDBMS 114 into a business object with attributes describing the particular object. For example, the business object representing the client's account may have attributes, such as a current balance attribute, an interest rate attribute, a lender attribute, etc., with each of these attributes being persisted as a data element in the database comprising RDBMS 114. Accordingly, the framework service may check for a negative balance by inspecting the current balance attribute of a business object representing the consumer's account.

Regardless of whichever means of obtaining the balance figure is used, if the framework service determines that the balance figure is negative, the framework service will go on to check to see whether the particular operator attempting to post the payment has permission to post a payment, when that payment results in a negative balance. If the operator has adequate permission, the POST_PAYMENT_TASK will proceed on as described, below. If the operator lacks the requisite permission, the framework service will initiate the undoing of the payment, thereby restoring RDBMS 114 to the state it was in prior to the payment being posted. One way that the framework service may restore RDBMS 114 to its pre-payment condition is to make use of a service that may be provided by the transaction process manager 902. The transaction process manager 902 may be designed to regard operations performed upon RDBMS 114 as being organized by “transactions”. In this context, a transaction is a set of operations to be performed upon RDBMS 114 in an all-or-nothing fashion. By organizing operations upon RDBMS 114 into transactions, the transaction process manager 902 may provide services, such as undoing incomplete transactions that were interrupted due to some form of error or programmatic intent (as in this example).

If the operator did, indeed, possess the requisite permission to post a payment that resulted in a negative balance, the POST_PAYMENT_TASK next calls an operation action 612, create_comment. The create_comment function permits a comment regarding the payment of the account (perhaps a comment regarding the circumstances surrounding the overpayment) to be associated with the account. Because the create_comment function does not deal with a pecuniary aspect of the consumer's account, it is categorized as an operation action, rather than a financial action. One manner in which a comment may be associated with the consumer's account is for a new “comment object” to be created. Such an object may possess at least two attributes: (1) a textual attribute which contains the comment itself; and (2) the account OID of the account to which the comment is to be associated. The create_comment function may interact with the newly created comment object, thereby properly setting its attributes. Using a persistence service, the newly created comment object data may be presented to the RDBMS 114 for storage.

After calling the create_comment operation action, the POST_PAYMENT_TASK issues a command to the workflow service, represented by logical box 616. The workflow service, like operation actions or financial actions, is a collection of functions made available to tasks, for the purpose of assisting tasks in the performance of their assigned operation. These collections of functions are linkable (either at run time or compile time) with the functions comprising the task/search/query 604 logical block. The functions comprising the workflow logical block 616 may also be communicated with via an application interface (API). The workflow functions cooperate to provide services directed toward organizing and assigning tasks to be performed by subscribing member's operators. These tasks typically relate to accounts handled by the particular subscribing member. For example, when an account becomes overdue, an item is created in the workflow database, which will cause an operator to be prompted to contact the delinquent account holder. To permit the client computing systems 104, 106, 108 to access workflow items (thereby prompting the users of the systems to perform the queued tasks), the client computing systems 104, 106, 108 may directly communicate with the workflow functions, rather than indirectly via the task functions 604. This communication may be facilitated by an API that permits interaction with the workflow functions 616. Returning to the example, the POST_PAYMENT_TASK next commands the workflow service 616 to delete any workflow item related to delinquent payment on the consumer's account, thereby preventing the consumer from receiving a communication regarding his delinquency after payment has been posted.

Having commanded the workflow service to delete any workflow item related to delinquent payment on behalf of the consumer, the POST_PAYMENT_TASK completes its operation by returning a message to the client computing system 104, 106, or 108, indicating that the payment has been successfully posted. The user interface of the client computing system 104, 106, or 108 may relay this information by presenting the operator with a dialog box stating that the payment was successfully posted.

Having described the operation of the OLTP 112 with respect to performing the operation of posting a payment to a particular account, the function, structure and relation of its various elements have been disclosed. One characteristic that RDBMS 114 may exhibit in any of the various embodiments presented herein is that of singular representation of a party within RDBMS 114, which permits building a customer view perspective. This view enables a user to see all account relationships for a given customer with only one place for profile information. This view has several advantages. For example, it helps to ensure up-to-date profile information, as updates are made only in one place rather than many. Additionally, it avoids multiple contact to customers regarding issues with their accounts. It allows for more effective cross-selling activities.

Stated another way, each party may be represented within RDBMS 114 only once, regardless of the number of relationships a particular party may have with a particular subscribing member. To illustrate this possible embodiment, if the consumer of our example, Carmen Rivera, were to have two separate loans financed by consumer finance company 100, RDBMS 114 would not have two separate records for Carmen Rivera stored therein. Instead, under this embodiment, RDBMS 114 would have a single record for Carmen Rivera, and that record would contain information about both loans. Thus, for example, effort is saved in attempting to multiply update information about Carmen Rivera, if he should request a new billing address.

In one possible embodiment, OLTP 112 has an additional feature, in that it is able to quickly and easily interface with third-party package software products that a particular subscriber might be using. To illustrate, consider a scenario in which the consumer finance company 100 entered payment information (such as payment sum, payment method, account number—the same data as that collected via the post payment GUI 800) into a spreadsheet package provided by a third party. Thus, at the end of the day, the consumer finance company 100 would have a spreadsheet containing information describing each of the payments having been made during the day. In one embodiment, the multi-environment scalable business system can post the payments recorded in the third-party spreadsheet package, thereby enabling the consumer finance company 100 to continue to use its preferred third-party software package.

To permit OLTP 112 to post the payments recorded in the third-party spreadsheet, a special framework service may be provided. Such a framework service converts flat files (a flat file can be a file containing 7-bit ASCII and using only ASCII-standard control characters, or can be any other example of a highly structured, generically formatted file) into an object or set of objects with which a task may interface. Consequently, the consumer finance company 100 can record its payments via the third-party spreadsheet package throughout a day, and output the day's worth of payment information as a flat file, which consumer finance company 100 then transmits (such as via file transfer protocol (FTP)) to OLTP 112. The aforementioned special framework service residing on the particular machine to which the flat file was transmitted responds to the transmission by converting the flat file into an object or set of objects, and calling a batch version of the POST_PAYMENT_TASK (i.e., a version of the POST_PAYMENT_TASK which can process a whole batch of payments, even though it is called but once). The batch-version POST_PAYMENT_TASK then proceeds to post the payments, making use of the financial actions, operation actions, rules and business objects in a manner congruous to that which was described above with reference to posting a payment entered via the post payment GUI 800.

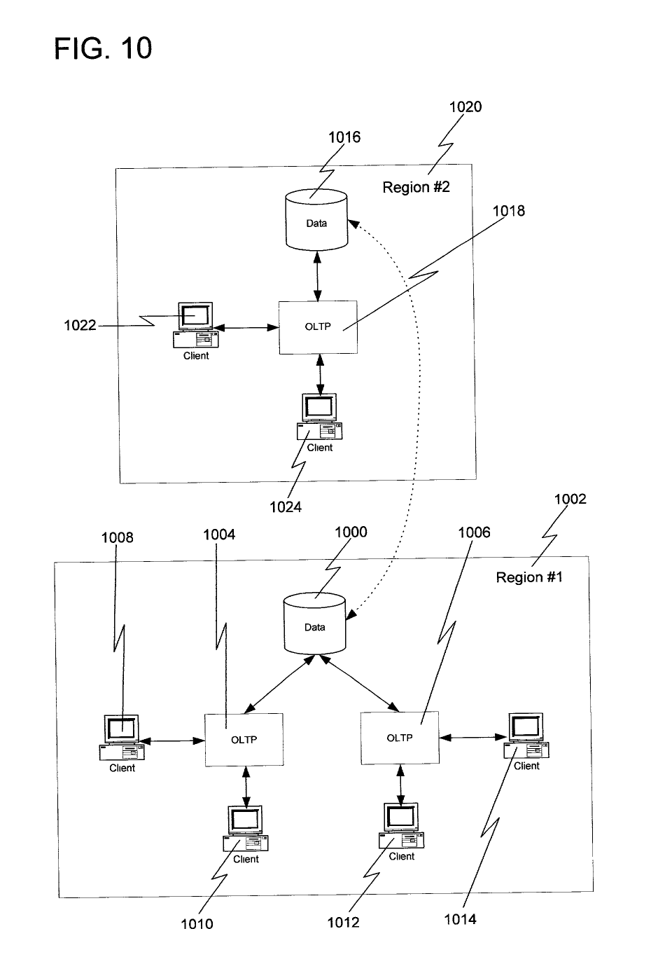

FIG. 10 depicts possible formations that the OLTP 112 and RDBMS 114 may take on in certain embodiments, so as to provide a rapid response to a client computing system that happens to be geographically remote with respect to the OLTP 112, or happens to have a low-speed connection to the OLTP. As can be seen from FIG. 10, a primary RDBMS 1000 may be located in a given region 1002. Also located in the same region 1002 as the primary RDBMS 1000 may be a multiplicity of OLTP complexes 1004, 1006. Additionally, client systems 1008, 1010, 1012, and 1014 may be located in region 1002, being served by OLTP complex 1004 and OLTP complex 1006. For the purpose of this discussion, RDBMS 1000, OLTP complex 1004 or 1006, and client system 1008, 1010, 1012, or 1014 are in the same region if the OLTP complex 1004 or 1006 is able to respond to its client system 1008, 1010, 1012, or 1014 with sub-second response times. To accommodate high-demand for service, several OLTP complexes 1004, 1006 may access a single RDBMS, so that each OLTP complex 1004 or 1006 services a corresponding set of subscribers. For example, in FIG. 10, OLTP 1004 services client systems 1008 and 1010, while OLTP 1006 services client systems 1012 and 1014. Thus, each OLTP 1004, 1006 is only accessed by half of the subscribing members, rather than all of the subscribing members.

As can also be seen from FIG. 10, a remote region 1020 may contain a remote RDBMS 1016 and a remote OLTP 1018. For the purposes of this discussion, region 1020 is remote with respect to region 1002 if the client systems therein could not be serviced by the OLTPs 1004 or 1006 in region 1002 with acceptable response times. In one possible embodiment, for example, region 1020 is remote if the client systems therein could not be serviced by the OLTPs 1004 or 1006 in region 1002 within sub-second response times.

A remote RDBMS 1016 may be periodically “updated” or “synchronized” so that the remote RDBMS 1016 and primary RDBMS 1000 contain identical sets of information at the moment of update. Stated otherwise, the primary RDBMS 1000 and remote RDBMS 1016 may synchronize data that has been modified. Thus, a remote OLTP 1018 may service clients 1022, 1024 in its remote region 1020 by accessing remote RDBMS 1016 for data, rather than attempting to access the primary RDBMS 1000. Later, the two RDBMSs 1000, 1016 are updated to reflect the transactions having occurred since their last update. This arrangement may be especially advantageous when the network connection between the two regions 1020 and 1002 is slow.

To ensure data integrity, certain data may be designated as being changeable only be OLTPs accessing a certain RDBMS. For example, data concerning the business accounts of client 1022, 1024 may be designated as being changeable only by OLTP 1018. Accordingly, any attempt to alter such data, if made from client system 1008, 1010, 1012, or 1014 would be invalid, as such data would be designated as read-only in RDBMS 1000.

From the foregoing detailed description and examples, it will be evident that modifications and variations can be made in the devices and methods of the invention without departing from the spirit or scope of the invention. Therefore, it is intended that all modifications and verifications not departing from the spirit of the invention come within the scope of the claims and their equivalents.

The claimed invention is:

1. An on-line financial processing and data storage system, the system being accessible to a client, the system comprising:
(a) a storage facility storing a hierarchy of functions, the hierarchy of functions including a plurality of task functions at a first level and a plurality of resource functions at a second level, and financial data; and
(b) a processor in data communication with the storage facility, the processor configured and arranged to:
(i) receive an operation instruction and an argument from the client;
(ii) invoke a task function in response to the operation instruction and pass the argument to the task function;
(iii) invoke at least one resource function in response to the invoked task function; and
(iv) retrieve and process a set of financial data from the database, the set of financial data being processed by the at least one invoked resource function.

2. The system of claim 1 wherein the at least one resource function includes a resource function that processes the set of financial data to achieve a pecuniary result.

3. The system of claim 2 wherein the at least one resource function includes a resource function that processes the set of financial data to achieve a non-pecuniary result.

4. The system of claim 3 wherein the at least one resource function includes a framework service.

5. The system of claim 1 wherein:
(i) the storage facility further stores rule functions; and
(ii) the processor is further configured and arranged to invoke at least one rule function in response to the invoked resource function.

6. The system of claim 1 wherein:
(i) the storage facility further stores rule functions; and
(ii) the processor is further configured and arranged to invoke at least one rule function in response to the invoked resource function, and the set of financial data is retrieved from the database in response to the rule function.

7. The system of claim 6 wherein the processor is further configured and arranged to execute a persistence service, the persistence service retrieving financial data from the storage facility in response to the rule function and instantiating a business object, wherein the business object is defined by the retrieved financial related data.

8. The system of claim 7 wherein the business object describes a business entity.

9. The system of claim 8 wherein the at least one rule function processes data within the business object and generates new data.

10. The system of claim 1 wherein the plurality of task functions is collected into a set of task functions, thereby forming a server.

11. The system of claim 10 further wherein the plurality of task functions is collected into a plurality of sets of task functions, each set forming a separate server.

12. The system of claim 11 further wherein the plurality of sets of task functions includes first and second sets of task functions, wherein the first set of task functions and the second set of task functions are mutually exclusive.

13. The system of claim 1 wherein the storage facility includes multiple storage units.

14. The system of claim 1 wherein the client is a computer program and the processor executes the client computer program.

15. The system of claim 1 wherein:
(a) the storage facility includes a remote memory facility and a plurality of local memory facilities, the financial data being stored in the remote memory facility and the hierarchy of functions being stored in the local memory facilities; and
(b) the system further comprises a plurality of processors, each processor in data communication with the remote storage facility and at least one of the local storage facilities, each processor configured and arranged to:
(i) receive an operation instruction and an argument from the client;
(ii) invoke a task function in response to the operation instruction and pass the argument to the task function;
(iii) invoke at least one resource function in response to the invoked task function; and
(iv) retrieve and process a set of financial data from the database, the set of financial data being processed by the at least one invoked resource function.

16. The system of claim 1 wherein:
(a) the client includes a terminal configured to receive input from an operator;
(b) the storage facility further includes a workflow database having a plurality of data, each data defining a job for execution by the operator; and
(c) the processor is further configured and arranged to:
(i) execute a set of workflow functions; and
(ii) manipulate data stored in the workflow database in response to execution of at least one of the workflow functions.

17. The system of claim 16 wherein the workflow database is configured to receive instructions from the client.

18. The system of claim 1 wherein:
(a) the memory facility further stores a set of GUI data for defining a graphical user interface;
(b) the processor is further configured to transmit the GUI data defining the graphical user interface to a subscriber memory facility for replication, the subscriber memory facility being accessible by the client.

19. The system of claim 18 further comprising:
(a) a subscriber memory facility, the subscriber memory facility storing data defining a graphical user interface; and
(b) a client having a display and a processor in data communication with the display and the remote memory facility, the processor configured to retrieve the GUI data from the remote memory facility and to generate a graphical user interface.

20. An on-line financial processing and data storage system, the system being accessible to a client, the system comprising:
(a) a storage facility storing a hierarchy of functions and financial data; and
(b) a processor in data communication with the storage facility, the processor configured and arranged to:
(i) receive an operation instruction and an argument from the client;
(ii) invoke a plurality of functions in response to the operation instruction and pass the argument to at least one of the invoked functions; and
(iii) retrieve and process a set of financial data from the database, the set of financial data being processed by at least one of the invoked functions, the set of financial data forming an object descriptive of a business entity.

21. The system of claim 20 wherein the plurality of functions includes a first resource function that processes the set of financial data to achieve a pecuniary result.

22. The system of claim 21 wherein the plurality of functions includes a second resource function that processes the set of financial data to achieve a non-pecuniary result.

23. The system of claim 22 wherein the plurality of functions includes a framework service.

24. The system of claim 23 wherein:
(i) the storage facility further stores rule functions; and
(ii) the processor is further configured and arranged to invoke at least one rule function in response to one of the invoked plurality of functions, and the set of financial data is retrieved from the database in response to the rule function.

25. The system of claim 24 wherein:
(a) the storage facility includes a remote memory facility and a plurality of local memory facilities, the financial data being stored in the remote memory facility and the plurality of functions being stored in the local memory facilities; and
(b) the system further comprises a plurality of processors, each processor in data communication with the remote storage facility and at least one of the local storage facilities, each processor configured and arranged to:
(i) receive an operation instruction and an argument from the client;
(ii) invoke a plurality of functions in response to the operation instruction and pass the argument to at least one of the invoked functions; and
(iii) retrieve and process a set of financial data from the database, the set of financial data being processed by at least one of the invoked functions, the set of financial data forming an object descriptive of a business entity.

26. The system of claim 25 wherein:
(a) the client includes a terminal configured to receive input from an operator;
(b) the storage facility further includes a workflow database having a plurality of data, each data defining a job for execution by the operator; and
(c) the processor is further configured and arranged to:
(i) execute a set of workflow functions; and
(ii) manipulate data stored in the workflow database in response to execution of at least one of the workflow functions.

27. The system of claim 26 wherein:
(a) the memory facility further stores a set of GUI data for defining a graphical user interface;
(b) the processor is further configured to transmit the GUI data defining the graphical user interface to a remote client memory facility for replication, the remote client memory facility being accessible by the client.

28. The system of claim 27 further comprising:
(a) a remote client memory facility, the remote client memory facility storing data defining a graphical user interface; and
(b) a client having a display and a processor in data communication with the display and the remote client memory facility, the processor configured to retrieve the GUI data from the remote client memory facility and to generate a graphical user interface.

29. A method of providing on-line financial processing and data storage, the method being responsive to input from a client, the method comprising:
(a) receiving an operation instruction and an argument from the client;
(b) invoking a task function in response to the operation instruction and passing the argument to the task function;
(c) invoking at least one resource function in response to the invoked task function; and
(d) retrieving and processing a set of financial data from the database, the set of financial data being processed by the at least one invoked resource function.

30. The method of claim 29 wherein the at least one resource function includes a resource function that processes the set of financial data to achieve a pecuniary result.

31. The method of claim 30 wherein the at least one resource function includes a resource function that processes the set of financial data to achieve a non-pecuniary result.

32. The method of claim 31 wherein the at least one resource function includes a framework service.

33. The method of claim 29 further comprising invoking at least one rule function in response to the invoked resource function, and retrieving the set of financial data from the database in response to the rule function.

34. The method of claim 33 further comprising executing a persistence service, the persistence service retrieving financial data from the storage facility in response to the rule function and generating a business object, wherein the business object is defined by the retrieved financial related data.

35. The method of claim 34 wherein the business object describes a business entity.

36. The method of claim 35 wherein the at least one rule function processes data within the business object and generates new data.

37. The method of claim 29 wherein the plurality of task functions is collected into a set of task functions, thereby forming a server.

38. The method of claim 37 further wherein the plurality of task functions are collected into a plurality of sets of task functions, each set forming a separate server.

39. The method of claim 38 further wherein the plurality of sets of task functions includes first and second sets of task functions, wherein the first set of task functions and the second set of task functions are mutually exclusive.

40. The method of claim 29 further comprising:
(e) executing a set of workflow functions; and
(f) manipulating data stored in a workflow database in response to execution of at least one of the workflow functions, each datum defining a job for execution by a client operator.

41. The method of claim 29 further comprising transmitting GUI data defining a graphical user interface for use by the client to a remote memory facility for replication, the remote memory facility being accessible by the client.

42. The method of 29 wherein the client is a computer program and the method further comprises executing the client.

43. An on-line financial processing and data storage system, the system being accessible to a client, the system comprising:
(a) a first on-line transaction processing system located in a first region;
(b) a first data storage facility storing financial data, located in the first region, the first data storage facility in data communication with the first on-line transaction processing system;
(c) a second on-line transaction processing system located in a second region, the second region being remote with respect to the first region; and
(d) the second data storage facility in data communication with the second on-line transaction processing system and the first data storage facility,
wherein the first and second data storage facilities store at least some common financial data and the first and second data storage facility synchronize at least some of the common financial data.

44. The system of claim 43 wherein the first data storage facility stores first and second sets of data, the first set of data changeable by only the first on-line transaction processing system and the second set of data being read-only to the first on-line transaction processing system.

45. The system of claim 43 wherein the first and second data storage facilities synchronize the common data that has been modified.

46. A component based framework for business domain specific processing comprising:
a plurality of executable modules, including first, second and third modules;
the first executable module, having a plurality of process rules and conditional logic, configured to receive a request, determine whether the request relates to a financial action or an operation action, and invoke the action to initiate a sequence of business rules and services; and
the second and third executable modules being responsive to the first executable module, the financial action, and the operation action, the second module being configured to provide services, the third module being configured to retrieve and update stored financial and associated information in a storage medium, wherein additional information related to the specific information may be automatically retrieved.

47. The framework of claim 46, wherein the first executable module further initiates the process rules and conditional logic to control performance of the plurality of executable modules.

48. The framework of claim 46, wherein the financial action and the operation action further provide domain-specific processing.

49. The framework of claim 46, wherein the financial action provides a pecuniary functionality, and operational action provides a non-pecuniary functionality.

50. The framework of claim 46, wherein the second executable module further comprise support services having domain processing trivialities for activation of the domain-specific processing, wherein the services are executed by the first executable module and the financial and operational actions.

51. The framework of claim 46, wherein the third executable module further comprises a plurality of domain-independent interfaces, having adaptability to be used by the first executable module, the financial actions, and operational actions, to map a plurality of attributes of a business process to the storage medium.

52. The framework of claim 51, wherein the storage medium further provides persisted data storage for mapping the attributes of the business process to the storage medium, wherein the persisted data is used by at least one business process.

53. The framework of claim 51, wherein the storage medium provides information for recreating documentation.

54. The framework of claim 46, wherein the plurality of executable modules further comprises a centralized module having configurable parameters, the plurality of modules informing the centralized module of a system parameter change, wherein the centralized module reacts to alter the system parameter if necessary.

55. The framework of claim 46, wherein the plurality of executable modules further comprises an interface, the interface electrically connecting modules, each module having a communicating protocol, wherein one module protocols is dissimilar from another.

56. The framework of claim 46, wherein the financial action and operational actions are executed by modules that are of different domains, adaptable to domain specific attributes.

57. A method for business domain-specific processing comprising:
combining a plurality of executable modules including first, second and third modules;
executing the first executable module, having a plurality of process rules and conditional logic, configured to receive a request, determine whether the request relates to a financial action and an operation action, and invoke the action to initiate a sequence of business rules and services; and
executing the second and third executable module being responsive to the first module, the financial action, and the operation action, the second module being configured to communicate with a plurality of external interfaces, the third module being configured to retrieve and update stored financial and associated information in a storage medium, wherein additional information related to the specific information may be automatically retrieved.

58. The method of claim 57, wherein executing the first executable module further comprises initiating the process rules and conditional logic to control performance of the plurality of executable modules.

59. The method of claim 57, wherein invoking the financial action and the operation action further provides domain-specific processing.

60. The method of claim 57, wherein invoking the financial action provides a pecuniary functionality, and invoking the operational action provides a non-pecuniary functionality;

61. The method of claim 57, wherein executing the second executable module further comprises activating support services having trivialities for activation of the domain specific processing, wherein the services are executed by the first executable module and the financial and operational actions;

62. The method of claim 57, wherein executing the third executable module further comprises initiating a plurality of domain-independent interfaces, having the adaptability to be used by the financial and operational actions, to map a plurality of attributes of a business process to the storage medium.

63. The method of claim 62, wherein the mapping of the plurality of attributes of the business process to the storage medium further provides storing the attributes of the business process in the storage medium, wherein persisted data is used by at least one business process.

64. The method of claim 63, wherein storing the attributes of the business process further comprises storing information for re-creating documentation.

65. The method of claim 57, wherein initiating the plurality of executable modules further comprises informing a centralized module of a system behavior, wherein the centralized module reacts to alter the system behavior if necessary.

66. The method of claim 57, wherein initiating the plurality of executable modules further comprises interfacing electrically connecting modules, each having a communicating protocol, wherein the module protocols may be different.

67. The method of claim 57, wherein invoking the financial action and operational actions further comprises executing by modules that are of different domains, adaptable to the domain specific attributes.

68. A component based system for business domain-specific processing comprising:
a plurality of interfaces electrically interconnected to at least one framework processor, wherein the framework processor comprises:
a plurality of executable modules including first, second and third module;
the first executable module, having a plurality of process rules and conditional logic, configured to receive a request, determine whether the request relates to a financial action and an operation action, and invoke the action to initiate a sequence of business rules and services; and
the second and third executable modules being responsive to the first executable module, the financial action, and the operation action, the second executable module being configured to provide services, the third executable module being configured to retrieve and update stored financial and associated information in a storage medium, wherein additional information related to the specific information may be automatically retrieved.
a storage medium, connected to the processor, for collecting customer information and archiving data;
a decision processor, interconnected to the framework processor, for reporting a plurality of activities relating to business transactions, wherein the decision processor performs data replication in plurality information repositories; and
a package solution process, interconnected to the framework processor, for providing a plurality of foreign knowledge bases.

69. The component-based system of claim 68, wherein the first executable module further initiates the process rules and conditional logic to control performance of the plurality of executable modules.

70. The component-based system of claim 68, wherein the financial action and the operation action further provide domain-specific processing.

71. The component based system of claim 68, wherein the financial action provides a pecuniary functionality, and operational action provides a non-pecuniary functionality.

72. The component-based system of claim 68, wherein the second executable module further comprises support services having technical details for activation of the domain specific processing, wherein the services are executed by the first executable module and the financial and operational actions.

73. The component-based system of claim 68, wherein the third executable module further comprises a plurality of domain-independent interfaces, having the adaptability to be used by the financial and operational actions, to map a plurality of attributes of a business process to the storage medium.

74. The component-based system of claim 73, wherein the storage medium further provides persisted data storage for mapping the attributes of the business process to the storage medium, wherein the persisted data is used by at least one business process.

75. The component-based system of claim 74, wherein the storage medium further utilizes the storage medium information for recreating documentation.

76. The component-based system of claim 68, wherein the plurality of executable modules having configurable parameters, informs a centralized module of a system behavior, wherein the centralized module reacts to alter the system behavior if necessary.

77. The component-based system of claim 68, wherein the plurality of executable modules further comprises an interface electrically connecting modules, each having a communicating protocol, wherein the module protocols may be different.

78. The component-based system of claim 68, wherein the financial action and operational actions are executed by modules that are of different domains, adaptable to domain specific attributes.

79. An article of manufacture for providing a multi-environment business system, the article of manufacture comprising a computer readable medium having local scalable business system instructions comprising:
a plurality of executable modules including first, second and third modules;
the first executable module, having a plurality of process rules and conditional logic, configured to receive a request, determine whether the request relates to a financial action or an operation action, and invoke the action to initiate a sequence of business rules and services; and
the second and third executable modules being responsive to the first module, the financial action and the operation action, the second module being configured to retrieve and update stored financial and associated information in the storage medium, wherein additional information related to the specific information may be automatically retrieved, the third module being configured to communicate with a plurality of external interfaces.

80. A method for executing a financial processing system, the system including code for executing one or more rule-based function, each rule-based function having a state, the method comprising:
executing the rule-based function;
determining the state of the rule associated with the rule-based function; and
when the state of the rule is false, completing execution of the rule-based function without regard to the rule.

81. The method of claim 80, wherein executing the rule-based function comprises processing the rule when the state of the rule is true.

82. The method of claim 80, wherein the determining the state of the rule further comprises storing the rules in a memory location, the memory location having the ability to be linked with a plurality of applications.

83. The method of claim 80, wherein the determining the state of the rule further comprises predetermining a default state of each rule stored in a rules-based database, each rule having a default state upon initialization of the system.

84. The method of claim 80, wherein the predetermining the setting of each rule further comprises specifying attributes including a target application, a priority level, and geographical location.

85. The method of claim 80 further comprising preventing execution of a transaction by enabling a first level permission preventing a user from executing the transaction, the first level permission having a second level permission, wherein the range allowed by the first level permission will be limited.

86. A rule-based system for processing financial information, the rule-based system comprising:
a database of rules, each rule having a selectable state;
a processor loaded with executable code, the code including at least one rule based function; and
wherein the code is programmed to access the database of rules, determine the state of one or more of the rules, and complete execution of the rule-based function.

87. The rule-based system of claim 86 further comprising an interface for accessing the database of rules, the interface capable of initiating a command having logic that accesses one or more rules.

88. The rule-based system of claim 86 further comprising a monitor for receiving status indicating the state for each rule.

89. The rule-based system of claim 86, wherein the processor function comprises logic for processing the rule when the state of the rule is true.

90. The rule-based system of claim 86, wherein the database further comprises memory location storing the rules, the memory location having the ability to be linked with a plurality of applications.

91. The rule-based system of claim 86, wherein the database further comprises a memory table defining a default state of each rule stored in a rules-based database, each rule having a default state upon initialization of the system.

92. The rule-based system of claim 86, wherein the determination of the state of one or more rules further comprises an attribute including a target application, a priority level, and geographical location.

93. The rule-based system of claim 86 further comprising logic for preventing execution of a transaction by enabling a first level permission preventing a user from executing the transaction, the first level permission having a second level permission, wherein the range allowed by the first level permission will be limited.
